(19) United States
(12) Patent Application Publication
(10) Pub. No.: US 2008/0160379 A1
(43) Pub. Date: Jul. 3, 2008

(54) High Performance Sofc Cathode Material in the 450C-650C Range

(76) Inventors: Sylvia Baron, London (GB); John Kilner, Surrey (GB); Robert Rudkin, Essex (GB)

Correspondence Address: MILES & STOCKBRIDGE PC, 1751 PINNACLE DRIVE, SUITE 500, MCLEAN, VA, 22102-3833, US

(21) Appl. No.: 11/910,913

(22) PCT Filed: Apr. 5, 2006
(86) PCT No.: PCT/GB06/01254

§ 371 Date: Mar. 8, 2008

(30) Foreign Application Priority Data
Apr. 8, 2005 (GB) 0507180.8

(51) Int. Cl. H01M 4/90; C01F 17/00; H01B 1/02; H01M 4/58; H01M 8/10

(52) U.S. Cl. 429/33; 423/263; 252/521.1; 252/520.21; 429/218.1; 429/46

(57) ABSTRACT

A novel cerium substituted perovskite material is disclosed which may be used as an electrode, current collector or membrane in an electrochemical device such as a solid oxide fuel cell (SOFC) or an oxygen generator. The novel material may be provided as a composite material if desired. It has been found that examples of this material and its composites exhibit greatly improved electrochemical and electronic performance when used as a cathode material, current collector, membrane or the like in an electrochemical device such as a fuel cell or oxygen generator for example.

The present invention describes the chemical formula for, and the stoichiometric limits of a novel perovskite material system which may be used as an active material in solid state electrochemical devices; particularly solid oxide fuel cell cathodes.

### Convention

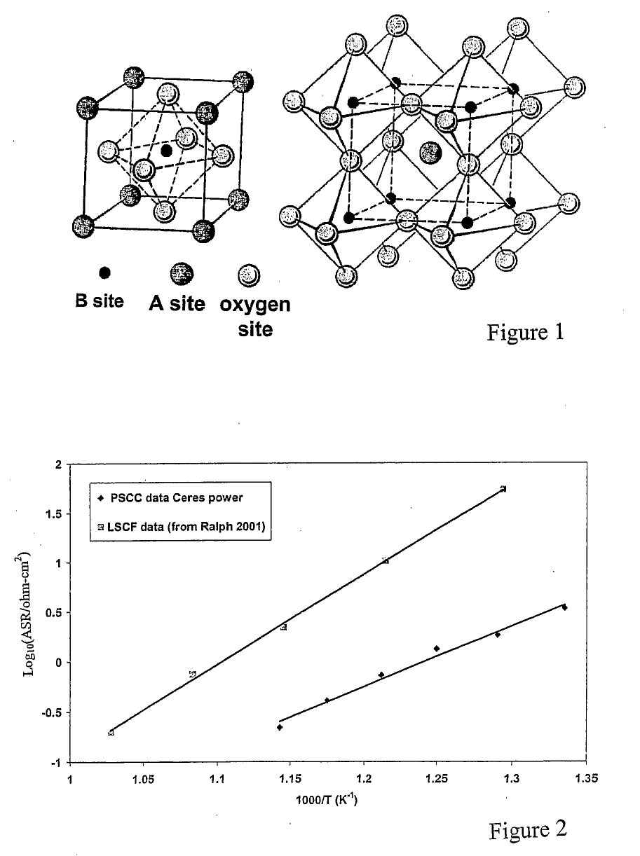

There are two cathode material systems currently used extensively in the fuel cell and oxygen generator field that define state of the art convention. Both are perovskites of general formula ABO₃ as shown in FIG. 1. The most established and widely reported is LSCF (La₍₁₋ₓ₎SrₓCo_{y}Fe_{(1-y)}O_{(3-δ)}, where 0<x<1 and 0<y<1), the second is LSM (La₍₁₋ₓ₎SrₓMnO_{(3-δ)} where 0<x<1) where δ here and in subsequent formulae represents the degree of oxygen deficiency. LSM is more often found in higher temperature operation solid oxide fuel cell (SOFC) systems comprising YSZ electrolytes. Typical operating temperatures for such systems are in the 750° C.-1000° C. range. LSCF based cathodes can operate at lower temperatures and LSCF is therefore the current material of choice for lower temperature YSZ electrolyte based systems and CGO electrolyte based systems. Typical operating temperatures for such systems are in the 600° C.-800° C. range.

### Limitations of Convention

In the field of SOFC technology, when considering performance and cost, there is a constant need to reduce the target operating temperature. The desire for reduced temperature operation drives the requirement for new single phase ceramic materials. Such materials must posses the necessary physical, chemical and electrical properties for acceptable electrode performance when operating the fuel cell at reduced temperatures. Two such key material properties are electrochemical activity and electronic conductivity.

The electrochemical activity and electronic conductivity of conventional cathode materials in the temperature range 450° C.-600° C. are limiting with respect to optimal fuel cell performance. This is the target temperature range of operation for the stainless steel supported, CGO electrolyte based fuel cell described in GB 2,368,450 and cathode materials capable of improved lower temperature performance are sought.

Many materials of perovskite type, ABO₃ have been used as cathode materials in SOFCs. The perovskite structure is illustrated schematically in FIG. 1. The larger A cation is coordinated by 12 oxygen ions and the smaller B cation by 6 oxygen ions.

PrCoO₃ is one such perovskite material and has been reported in U.S. Pat. No. 6, 319,626 as a potential cathode material for use in YSZ electrolyte based systems operating at temperatures in the region of 800° C. Results have also been published on various derivatives of the parent perovskite with lower valence cations substituted onto the A site. An example of such a material is Pr_{0.8}Sr_{0.2}CoO₃ (PSC).

It is an aim of an embodiment of the present invention to provide a material with improved performance in the temperature range utilised by the fuel cell described in GB 2,368,450 typically below 800° C., preferably below 700° C. and more preferably between 450° C.-600° C.

According to a first aspect of the present invention there is provided a material defined by the formula:

Ln₍₁₋ₓ₎AeₓB_{(1-y)}Ce_{y}O_{(3-δ)};

| | |
|---|---|
| where: | Ln is any of La, Ce, Pr, Nd, Pm, Sm, Eu, Gd, Tb, Dy, |
| | Ho, Er, Tm or Yb |
| | Ae is any element from the alkaline earth family such as |
| | Ca, Sr and Ba |
| | B is any of Fe, Co, Ni, Cu, Mg, Ti, V, Cr, Mn, Nb, Mo, |
| | W, Zr |
| | with 0 < x < 1 and y < 0.5. |

An aspect of this family of perovskite materials that specifically defines its novelty is that with reference to the general conventional perovskite notation ABO₃, Cerium is substituted onto the ‘B’ site.

It has been found that examples of this material exhibit greatly improved electrochemical and electronic performance when used as an electrode material, current collector, membrane or the like in an electrochemical device such as a fuel cell or oxygen separator for example, especially below 800° C. preferably below 700° C. and more preferably in the temperature range 450° C.-600° C. The use of cerium as the substituting B site ion also improves cathode-electrolyte chemical compatibility when the material is used as a cathode within ceria based electrolyte fuel cell systems. A further advantage of the material of the first aspect of the present invention is that when compared to materials with undoped B site stoichiometry, the thermal expansion coefficient (TEC) is reduced, reducing the likelihood of separation from adjoining materials, when in use, due to temperature variations. Examples of this material can be obtained by standard solid state techniques. The perovskite material system PSCC (Pr_{0.5}Sr_{0.5}Ce_{0.2}Co_{0.8}O_{(3-δ)} is a specific example of a family of materials defined by the first aspect of the present invention.

According to a second aspect of the present invention there is provided a composite material including Ln₍₁₋ₓ₎AeₓB_{(1-y)}Ce_{y}O_{(3-δ)} as described above in the first aspect of the present invention, with a second material being an oxygen ion conductor. An example of such an oxygen ion conducting material system to be provided with the material of the first aspect of the present invention to provide a composite is ceria (CeO₂) and solid solutions of ceria with other oxides; a specific example of such a solid solution being CGO (Ce₍₁₋ₓ₎GdₓO_{(2-δ)} where 0<x<0.5). A second example of such an oxygen ion conducting system to be provided with the material of the first aspect of the present invention to provide a composite system is zirconia (ZrO₂) and solid solutions of zirconia with other oxides, examples of such a solid solution being YSZ (Zr₍₁₋ₓ₎YₓO_{(2-δ)} where 0<x<0.1). An example of such a composite material is (1-z)PSCC/zCGO where z is the volume fraction of CGO.

According to a third aspect of the present invention there is provided an electrode material, current collector or membrane for use in any solid state electrochemical device, wherein the electrode material, current collector or membrane comprises the material according to the first aspect of the present invention or the composite material according to the second aspect of the present invention. The electrode material is preferably a mixed electronic and oxide ion conducting electrode material. Examples of the third aspect of the present invention include an electrode material on ceria based electrolytes, an electrode material on any electrolyte with a ceria based interface layer, an SOFC cathode, an SOFC current collector, an electrode material in an electrically driven oxygen separator and a membrane in a pressure driven oxygen separator.

According to a fourth aspect of the present invention there is provided an electrochemical device, such as a SOFC or an oxygen generator including an electrode, current collector or membrane including the material according to the first aspect of the present invention or the composite material according to the second aspect of the present invention.

The material and its composites are found to work particularly well at relatively low temperatures such as below 800° C., below 700° C. or below 600° C. such as between 450° C. and 600° C.

Examples of the present invention will now be described with reference to the accompanying drawings, in which:

FIG. 1 shows a schematic of a general perovskite structure;

FIG. 2 shows a graphical comparison of the cathode area specific resistance vs. reciprocal temperature for an example of a cathode of the material according to the present invention (PSCC) and LSCF;

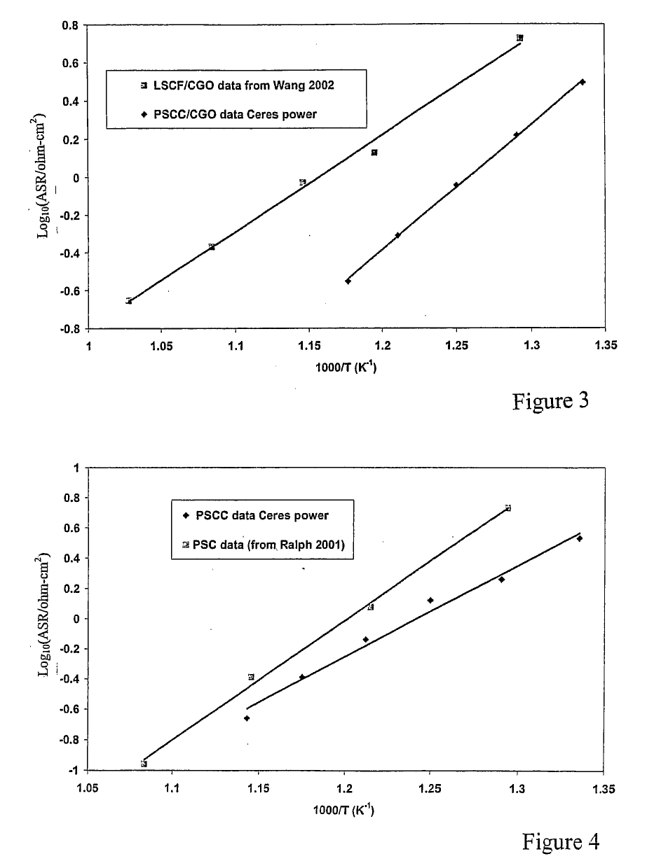

FIG. 3 shows a graphical comparison of the cathode area specific resistance vs. reciprocal temperature for an example of a cathode made from a composite material according to the present invention (PSCC/CGO) and a composite of LSCF/CGO;

FIG. 4 shows a graphical comparison of cathode area specific resistance vs. reciprocal temperature for an example of a cathode of a material according to the present invention (PSCC) and PSC;

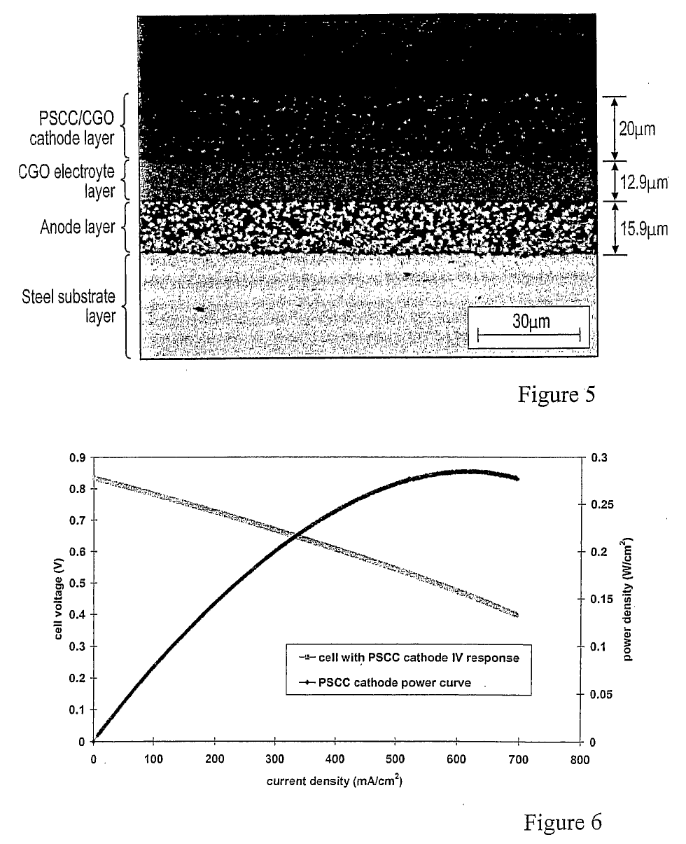

FIG. 5 is a scanning electron microscope view of a fuel cell cross-section with a composite PSCC/CGO cathode and FIG. 6 shows a power curve taken at 570° C. for a fuel cell as described in GB 2,368,450 processed with a PSCC/CGO cathode.

The material of the present invention could be produced by any suitable standard process such as producing a powder by mixed oxide, nitrate, glycine/nitrate routes. The powder would then be made into a usable media for cathode processing such as by providing screen printing ink, tape casting slurry, spray suspension etc. It would then be deposited on a fuel cell electrolyte or support and sintered.

FIG. 2 shows the cathode area specific resistance (ASR) vs. reciprocal temperature for a PSCC cathode measured by the applicant and an LSCF cathode using data from Ralph: Solid State Ionics, Volume 159, Issues 1-2, March 2003, pages 71-78. The ASR was taken as the sum of the cathode low frequency and high frequency arc resistances obtained by AC impedance spectroscopy. As can be seen, the PSCC cathode exhibited much lower ASR for a given temperature.

FIG. 3 shows a similar comparison between a 70/30 wt % PSCC/CGO composite and a 70/30 wt % LSCF/CGO composite using data from Wang: Solid State Ionics, Volumes 152-153, December 2002, Pages 477-484. As can be seen, the 70/30 wt % PSCC/CGO composite exhibited much lower cathode area specific resistance for a given temperature.

FIG. 4 shows a similar comparison between PSCC and PSC using data from Ralph: Solid State Ionics Volume 159, Issues 1-2, March 2003, pages 71-78. As can be seen, the PSCC exhibited much lower cathode area specific resistance for a given temperature.

FIG. 5 shows a scanning electron microscope view of a fuel cell cross-section with a PSCC/CGO cathode showing a robust electrolyte cathode/electrolyte interface. The fuel cell was found to exhibit good compatibility between the electrolyte and the cathode post processing.

FIG. 6 shows a power curve taken at 570° C. for a fuel cell as in GB 2,368,450 processed with a PSCC/CGO cathode. The power curve demonstrates practical power densities in the target temperature range.

1. A material defined by the formula:
Ln₍₁₋ₓ₎AeₓB_{(1-y)}Ce_{y}O_{(3-δ)};
where: Ln is any of La, Ce, Pr, Nd, Pm, Sm, Eu, Gd, Tb, Dy, Ho, Er, Tm or Yb
Ae is any member of the alkaline earth family such as Ca, Sr or Ba; and
B is any of Fe, Co, Ni, Cu, Mg, Ti, V, Cr, Mn, Nb, Mo, W, Zr
with δ>0, 0<x<1 and 0<y<0.5.

2. A composite material comprising the material according to claim 1 and a further material, the further material being an oxygen ion conductor.

3. A composite material according to claim 2, wherein the further material includes ceria.

4. A composite material according to claim 3, wherein the further material is a solid solution of ceria with other oxides.

5. A composite according to claim 4, wherein the solid solution is CGO (Ce₍₁₋ₓ₎GdₓO_{(2-δ)} where 0<x<0.5)

6. A composite material according to claim 2, wherein the further material includes zirconia.

7. A composite material according to claim 6, wherein the further material is a solid solution of zirconia with other oxides.

8. A composite material according to claim 7, wherein the solid solution is (Zr₍₁₋ₓ₎YₓO_{(2-δ)} where 0<x<0.1).

9. An electrode for an electrochemical device including the material according to claim 1.

10. An electrode according to claim 9, provided on a ceria based electrolyte.

11. An electrode according to claim 9, provided on an electrolyte with a ceria based interface layer.

12. A current collector for an electrochemical device, the current collector including the material according to claim 1.

13. A membrane for an electrochemical device, the membrane including the material according to claim 1.

14. An electrochemical device including an electrode, current collector or membrane including the material according to claim 1.

15. A solid oxide fuel cell with a cathode including the material according to claim 1, an electrolyte and an anode.

16. A solid oxide fuel cell with a current collector including the material according to claim 1.

17. An oxygen generator with at least one electrode according to claim 9.

18. An oxygen generator with a membrane including the material according to claim 1.

19-24. (canceled)

25. An electrode for an electrochemical device including the composite material according to claim 2.

26. A current collector for an electrochemical device, the current collector including the composite material according to claim 2.

27. A membrane for an electrochemical device, the membrane including the composite material according to claim 2.

28. An electrochemical device including an electrode, current collector or membrane including the composite material according to claim 2.

29. A solid oxide fuel cell with a cathode including the composite material according to claim 2, an electrolyte and an anode.

30. A solid oxide fuel cell with a current collector including the composite material according to claim 2.

31. An oxygen generator with a membrane including the composite material according to claim 2.
